(19) United States
(12) Patent Application Publication
(10) Pub. No.: US 2014/0139353 A1
(43) Pub. Date: May 22, 2014

(54) INDICATOR SYSTEM

(71) Applicant: Wolverine World Wide, Inc., Rockford, MI (US)

(72) Inventors: Craig M. Wojcieszak, Medford, MA (US); Marc R. Loverin, Scituate, MA (US); Donna White, Dracut, MA (US); Noel M. Rix, Rye, NH (US)

(73) Assignee: Wolverine World Wide, Inc., Rockford, MI (US)

(21) Appl. No.: 14/083,924

(22) Filed: Nov. 19, 2013

Related U.S. Application Data
(60) Provisional application No. 61/729,164, filed on Nov. 21, 2012.
(60) Provisional application No. 61/782,635, filed on Mar. 14, 2013.
(60) Provisional application No. 61/874,383, filed on Sep. 6, 2013.

(51) Int. Cl. G08B 5/36

(52) U.S. Cl. CPC G08B 5/36
USPC 340/870.16

(57) ABSTRACT

An indicator system includes a human perceptible indicator, a motion-activated switch, and a controller in electrical communication with the indicator and the motion activated switch. The controller includes a non-transitory memory storing first and second indicator sequences, and a counter counting a number of activations of the motion-activated switch. The controller causes activation of the indicator according to the first indicator sequence when the number of switch activations is less than a first threshold count, and according to the second indicator sequence when the number of switch activations is greater than or equal to the first threshold count, and less than a second threshold count.

### TECHNICAL FIELD

This disclosure relates to an indicator system for activating a human perceptible indicator based on one or more indicator sequences.

### BACKGROUND

Lighting systems are incorporated in many different articles including apparel (e.g., jackets, shirts, pants, etc.), shoes (e.g., children's shoes, athletic shoes, etc.), hats, and gloves. Generally, the lighting system incorporated in these articles provides an observer with a greater likelihood of seeing a person having an article of clothing that includes the lighting system. In addition, incorporating a lighting system on a clothing article provides a fashion statement and/or the lit article provides a safety aspect to its wearer.

### SUMMARY

One aspect of the disclosure provides an indicator system. The indicator system includes a human perceptible indicator, a motion-activated switch, and a controller. The controller is in electrical communication with the indicator and the motion activated switch. The controller includes a non-transitory memory storing first and second indicator sequences, and a counter counting a number of activations of the motion-activated switch. The controller activates of the indicator according to the first indicator sequence when the number of switch activations is less than a first threshold count, and according to the second indicator sequence when the number of switch activations is greater than or equal to the first threshold count, and less than a second threshold count.

Although the indicator system may include a motion-activated switch, the system may alternatively or additionally include other types of sensors capable of providing readings representative of essentially any physical property or other phenomenon. For example, the system may include internal sensors that measure physical properties or other phenomena within the article, such as forces with an article of footwear or temperature within a garment. As another example, the system may include external sensors that measure physical properties or other phenomena outside the article, such as ambient light and other electromagnetic fields, magnetic fields, electric fields, position and orientation. In one embodiment, the controller is capable of receiving input from one or more sensors, and is configured to control the indicator based on the input from the sensors. For example, the controller may determine the indicator sequence or some other characteristic of the indicator output based on the sensor readings. The controller may determine indicator output based on essentially any aspect of the sensor readings, such as the values of the sensor readings, the number of sensor readings, the rate of sensor readings or a pattern followed by the sensor readings.

Implementations of the disclosure may include one or more of the following features. In some implementations, during activation of the indicator according to the one of the indicator sequences, if the motion-activated switch is activated, the activation of the indicator according to that indicator sequence is uninterrupted. The counter may count the number of switch activations during activation of the indicator according to one of the indicator sequences, and the controller may execute that indicator sequence a number of times based on the counted number of switch activations. Additionally or alternatively, the counter may reset to zero when the number of switch activations is equal to the second threshold count. In some examples, the controller decrements the counter each time it executes an indicator sequence.

In some implementations, the indicator is a light emitter, which may include at least one light emitting diode. The light emitting diode may include a multi-color light emitting diode. Additionally, the first indicator sequence may include a first color of the multi-color light emitting diode, and the second sequence may include a second color of the multi-color light emitting diode.

In some examples, the first indicator sequence is different than the second indicator sequence. The indicator may be disposed remotely from the motion-activation switch.

In some examples, the system further includes a power source in electrical communication with at least one of the indicator, the motion-activated switch, or the controller. The power source may provide a constant or intermittent delivery of current to the indicator. Additionally or alternatively, the controller may activate the indicator by allowing the power source to power the indicator.

Another aspect of the disclosure provides an indicator system including a human perceptible indicator, a motion-activated switch, and a controller in electrical communication with the indicator and the motion activated switch. The controller includes non-transitory memory and a counter. The non-transitory memory stores first and second indicator sequences. The counter counts a number of activations of the motion-activated switch and determines a rate of activations of the motion-activated switch. The controller activates the indicator according to the first indicator sequence when the rate of switch activations is less than or equal to a threshold rate; and according to the second indicator sequence when the rate of switch activations is greater than the threshold rate and the number of switch activations at the second rate is greater than a threshold count.

In some implementations, activation of the indicator according to one of the indicator sequences, if the motion-activated switch is activated, the activation of the indicator according to that indicator sequence is uninterrupted. The counter may count the number of switch activations during activation of the indicator according to one of the indicator sequences, and the controller may execute that indicator sequence a number of times based on the counted number of switch activations (e.g., according to a relationship with the switch activation count). Additionally or alternatively, the counter may reset to zero when the number of switch activations is equal to a second threshold count. The controller may decrement the counter each time an indicator sequence is executed.

In some examples, the controller activates the light emitter according to the second indicator sequence when the number of activations is greater than the threshold count at the second threshold rate and the motion-activated switch is unactivated for at least a first time period. The controller may cease activation of the indicator for a second time period, and then may cause activation of the indicator according to one of the indicator sequences.

In some implementations, when switch activation rate is less than the threshold rate, the controller decrements the counter for each activation of the motion-activated switch. When the switch activation rate is less than the threshold rate and the switch count is less than the threshold count, the controller may activate the indicator according to the first indicator sequence. Moreover, wherein when the switch activation rate drops to zero within a threshold period of time, and the switch count is greater than the threshold count, the controller may activate the indicator according to the second indicator sequence a number of times.

In some implementations, the indicator is a light emitter, which may include at least one light emitting diode. The light emitting diode may include a multi-color light emitting diode. Additionally, the first indicator sequence may include a first color of the multi-color light emitting diode, and the second sequence may include a second color of the multi-color light emitting diode.

In some examples, the first indicator sequence is different than the second indicator sequence. The indicator may be disposed remotely from the motion-activation switch.

In some implementations, the system includes a power source in electrical communication with at least one of the indicator, the motion-activated switch or the controller. The power source may provide at least one of a constant or intermittent delivery of current to the indicator. Moreover, the controller may activate the indicator by allowing the power source to power the indicator.

Another aspect of the disclosure provides an indicator system that includes a human perceptible indicator, a motion-activated switch, and a controller in electrical communication with the indicator and the motion activated switch. The controller includes non-transitory memory storing first and second indicator sequences, and a counter counting a number of activations of the motion-activated switch and determining a rate of activations of the motion-activated switch. The controller activates the indicator according to the first indicator sequence when the rate of switch activations is less than or equal to a threshold rate, and according to the second indicator sequence when the rate of switch activations is greater than the threshold rate. The counter counts the number of switch activations during activation of the indicator according to the second indicator sequence, and the controller executes that indicator sequence a number of times based on the counted number of switch activations.

In some implementations, during activation of the indicator according to the one of the indicator sequences, if the motion-activated switch is activated, the activation of the indicator according to that indicator sequence is uninterrupted. The controller may decrement the switch count each time an indicator sequence is executed.

In some examples, the indicator is a light emitter, which may include at least one light emitting diode. The system may include a power source in electrical communication with at least one of the indicator, the motion-activated switch or the controller.

In yet another aspect of the disclosure, a method of activating a human perceptible indicator that includes counting a number of activations of a motion-activated switch. The method also includes activating the indicator according to a first indicator sequence when the number of switch activations is less than a first threshold count, and according to a second indicator sequence when the number of switch activations is greater than or equal to the first threshold count, and less than a second threshold count.

Implementations of the disclosure may include one or more of the following features. In some implementations, the method further includes delivering at least one of a constant or intermittent current to the indicator. Additionally or alternatively, while activating the indicator according to one of the indicator sequences, if the motion-activated switch is activated, that indicator sequence is uninterrupted. In some examples, the method further includes counting the number of switch activations during one of the indicator sequences, and executing at least one of the indicator sequences a number of times equal to the number of switch activations.

In yet another aspect of the disclosure, a method of activating a human perceptible indicator includes counting a number of activations of a motion-activated switch and determining a rate of activation of the motion-activated switch. The method also includes activating the indicator according to a first indicator sequence when the rate of switch activations is less than or equal to a threshold rate, and according to a second indicator sequence when the rate of switch activations is greater than the threshold rate and the number of switch activations at the second rate is greater than a threshold count.

In some implementations, the method further includes delivering at least one of a constant or intermittent current to the indicator. Additionally or alternatively, while executing one of the indicator sequences, if the motion-activated switch is activated, that indicator sequence is uninterrupted. In some examples, the method further includes counting the number of switch activations during one of the indicator sequences, and executing at least one of the indicator sequences a number of times equal to the number of switch activations.

In some implementations, the method further includes activating the indicator according to the second indicator sequence when the number of switch activations is greater than the threshold count at the second threshold rate and the motion-switch is not activated for at least a first period of time. The method may also include ceasing activation of the indicator for a second period of time and then activating the indicator according to one of the indicator sequences. In some examples, the method includes resetting the count of switch activations to zero when the number of switch activations is equal to a second threshold count.

Another aspect of the disclosure provides a method of activating a human perceptible indicator. The method includes counting a number of activations of a motion-activated switch, determining a rate of activation of the motion-activated switch, and activating the indicator according to a first indicator sequence when the rate of switch activations is less than or equal to a threshold rate, and according to a second indicator sequence when the rate of switch activations is greater than the threshold rate. The method also includes counting the number of switch activations during activation of the indicator according to the second indicator sequence and executing the second indicator sequence a number of times based on the counted number of switch activations while the rate of switch activations is greater than the threshold rate.

During activation of the indicator according to the one of the indicator sequences, if the motion-activated switch is activated, the activation of the indicator according to that indicator sequence may be uninterrupted. The method may include decrementing the switch count each time an indicator sequence is executed.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an exemplary indicator system.

FIG. 1B is a schematic view of an exemplary indicator system.

FIGS. 1C and 1D are schematic views of exemplary motion activated switches.

FIG. 1E is a schematic representation of a magnetic switch.

FIG. 2 is a flow diagram depicting operation of the indicator system of FIG. 1A.

FIG. 3 is a flow diagram depicting operation of the exemplary indicator system of FIG. 1B.

FIG. 4 is a flow diagram depicting operation of the exemplary indicator system of FIG. 1B.

FIGS. 5-6B are side views of an article of footwear including an exemplary indicator system.

FIG. 7A is a front view of a jacket including an exemplary indicator system.

FIG. 7B is a back view of a jacket including an exemplary indicator system.

FIG. 8 is an exemplary arrangement of operations for a method of illuminating a light emitter.

FIG. 9 is an exemplary arrangement of operations for a method of illuminating a light emitter.

FIG. 10 provides another exemplary arrangement of operations for a method of activating a human perceptible indicator.

FIG. 11 is a top view of an alternative spring switch.

FIG. 12 is a schematic view of an exemplary indicator system.

FIG. 13 is a flow chart showing the general steps of one method for illuminating a plurality of light emitters.

FIG. 14 is a perspective view of a shoe incorporating a sound sensor and a plurality of light emitters.

Like reference symbols in the various drawings indicate like elements.

### DETAILED DESCRIPTION

Indicator systems incorporated in objects such as apparel (e.g., jackets, shirts, pants), shoes (e.g., children's shoes, athletic shoes), hats, and gloves may provide a fashion statement to a wearer and a highly visible object that assists others in seeing the wearer of the object, when the indicator system involves light.

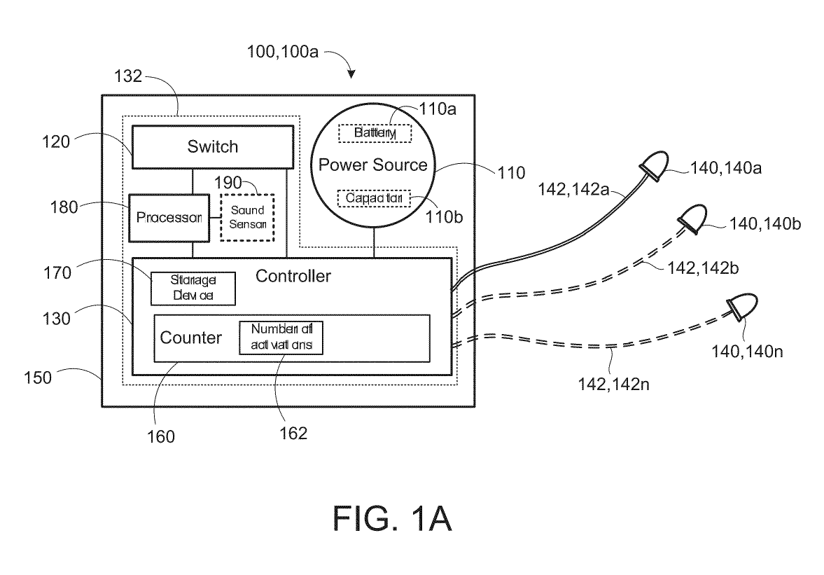

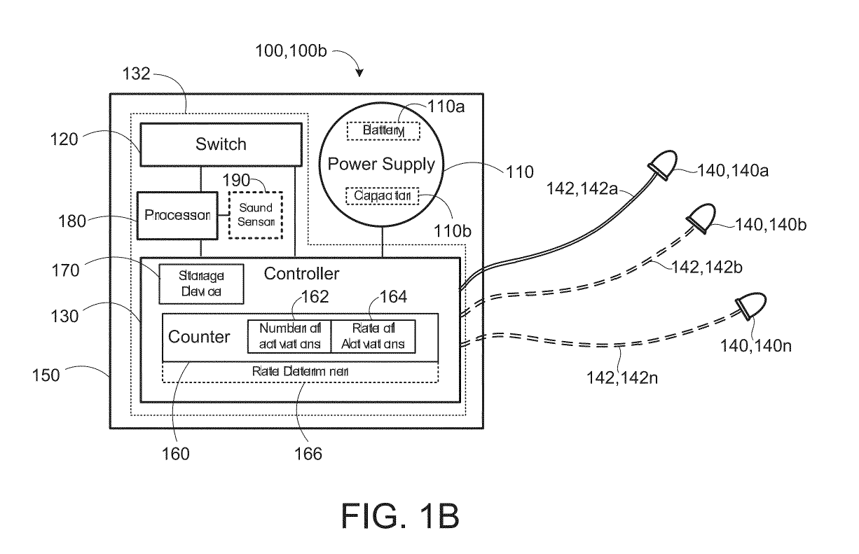

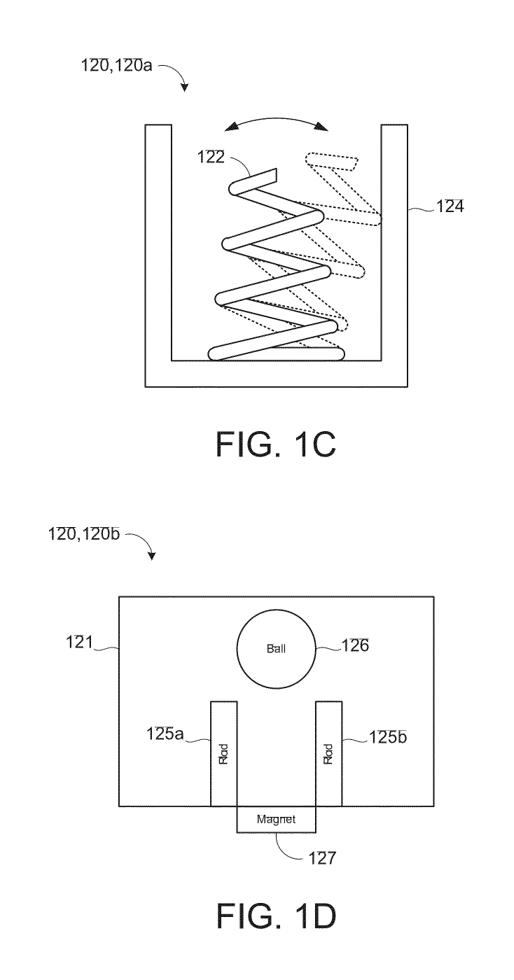

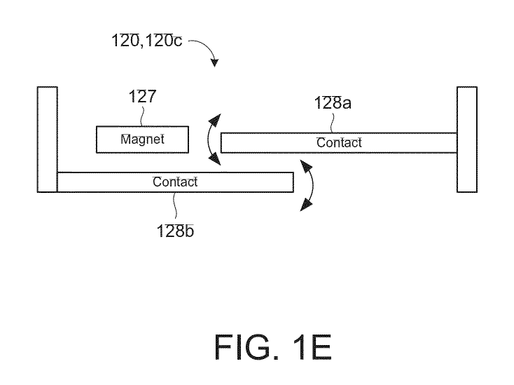

Referring to FIGS. 1A-1B, in some implementations, an indicator system 100, 100a includes a power source 110, a switch 120, a controller 130, and one or more human perceptible indicators 140, 140a-n. The examples discussed include light emitters 140 as the perceptible indicators 140; however, other indicators are possible as well, such as palpable indicators (e.g., vibrating and other haptic device), sound indicators, temperature indicators, and scent indicators. The controller 130 electrically connects to the power supply 110 and the switch 120. The controller 130 is also electrically connected via electrical wires 142 to the perceptible indicator(s) 140 (e.g., light emitters). A system housing 150 (e.g., as a compact unit) is configured to support the power source 110, the switch 120, the controller 130 (e.g., in a confined area). In some examples, the housing 150 is configured to support the perceptible indicator(s) 140. Alternatively, the perceptible indicator(s) 140 may be disposed remotely from the housing 150. The housing 150 is generally a rectangular shape, but may be any shape to accommodate components of the indicator system 100 or to fit onto an article of clothing. The housing 150 may define apertures (not shown) to releasable connect the electrical wires 142 from the controller 130 to the perceptible indicator(s) 140. Additionally, the housing 150 can be made of plastic or any other suitable material.

The power source 110 may be a battery 110a (e.g., lithium ion, silver-zinc, etc.) and/or a capacitor 110b. The power source 110 may have the capacity to power the perceptible indicator(s) 140 for about 100,000 hours. In some examples, a 20 minute charge of the power source 110 provides power for about one hour of continuous light emission from a light emitter type indicator 140. Therefore, a one hour charge may provide about 3 hours of continuous light emission by the light emitter 140. The battery 110a may be replaceable or permanently held in the housing 150. Additionally or alternatively, the battery 110a may be a disposable and/or rechargeable battery.

In some implementations, the controller 130 includes a counter 160 for counting the number 162 of activations of the switch 120. In some examples, the counter 160 counts switch activations over a period of time for determining a rate 164 of activation of the switch 120. In some implementations, the counter 160 performs both functions of counting the number 162 of switch activations and determining the rate 164 of switch activation. While in other implementations, the counter 160 simply counts switch activations and a rate determiner 166 in communication with counter determines the rate 164 of switch activation.

The controller 130 includes a storage device 170 (e.g., non-transitory memory) for storing one or more indicator sequences. The storage device 170 may be any type of persistent or non-persistent storage, for example, flash memory, random access memory (RAM), a hard disk or other suitable memory device. The controller 130 may be an integrated circuit, a processor circuit, or a control circuit disposed on a circuit board 132. In some examples, the controller 130 is a system on a chip or system on chip (SoC or SOC), which is an integrated circuit (IC) that integrates all components of an electronic system into a single chip. As such, the switch 120, the controller 130, and the storage device 170 may be disposed on the circuit board 132 housed in the housing 150.

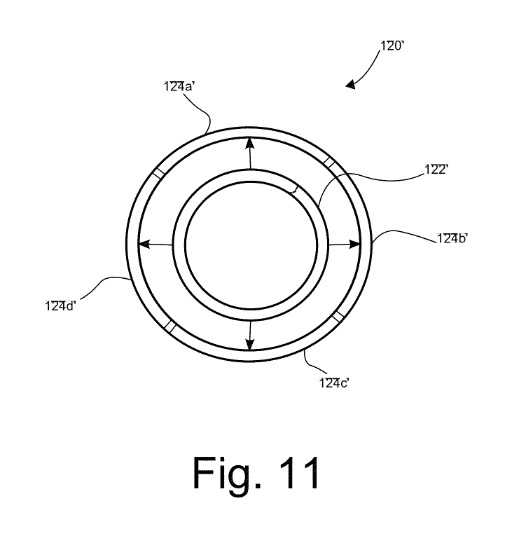

Referring to FIG. 1C, in some implementations, the switch 120 is a motion-activated switch 120a (i.e., relative motion of the switch 120 causes activation of the switch 120). In some examples, the switch 120a includes a coil spring 122 disposed adjacent a switch contact 124. When the coil spring 122 touches the switch contact 124, the switch 120a is activated and creates a closed circuit. The switch is not activated when the switch 120 is not in motion, the coil spring 122 remains in an unbiased position not in contact with the switch contact 124. The spring switch may alternatively be configured to differentiate between motions in different directions, such as between up/down and left/right motions (not shown). In such embodiments, the spring switch may include a plurality of separate switch contacts that are arranged at different locations about the spring so that when the spring bends in different directions it engages different switch contacts. The number of switch contacts may vary depending on the desired resolution of the switch. For example, in the context of a switch with four directions 120′, the switch contacts 124a′, 124b′, 124c′ and 124d′ may form a circular sleeve around the spring 122′ and each switch contact may define a quadrant of the circular sleeve (See FIG. 11). When sufficient motion occurs, the end of the spring 122′ will bend (as represented by the arrows) to touch a switch contact 124a′, 124b′, 124c′ or 124d′ in line with the direction of motion. In this embodiment, the controller may be configured to separately receive activations from the different switch contacts 124a′, 124b′, 124c′ and 124d′. By determining which switch contact 124a′, 124b′, 124c′ and 124d′ was touched by the spring 122′, the controller can determine the direction of motion.

Referring to FIG. 1D, in some implementations, the switch 120b is housed in a non-conductive compartment 121 and includes two rods 125a, 125b, one positively charged and the other negatively charged, a moving ball 126, and a magnet 127. When the ball 126 contacts both rods 125a, 125b simultaneously, a closed circuit is created and the switch 120b is activated. The magnet 127 attracts the ball 126 towards the rods 125a, 125b when the switch 120b is not in motion.

Referring to FIG. 1E, in some implementations, the switch 120c is a magnetic switch 120c (e.g., a reed switch). The magnetic switch 120c includes a pair of bendable, magnetizable, metal contacts 128a, 128b. When the switch 120c is not activated, the end of each contact 128a, 128b is separated by a relatively small distance from the other contact 128a, 128b. The switch 120c includes a magnet 127 that causes the contacts 128a, 128b to come together when the switch 120c is activated, and the circuit is closed. Although the switches 120 mentioned include the spring switch 120a, the ball switch 120b and the magnetic switch 120c, other suitable electrical switches 120 may be used as well.

In some examples, the perceptible indicator 140 is in electrical communication with the controller 130 and the power source 110. The perceptible indicator 140 may be a light emitting diode (LED) or a multi-color light emitting diode (LED) and the first and second indicator sequences can each have a different color or sequence of colors of the multi-color LED. Moreover, the first indicator sequence may be different than the second indicator sequence. Although an LED in this example, the perceptible indicator 140 may be essentially any other type of light emitter or visual indicator, such as an electroluminescent light, incandescent lamp, liquid crystal display, electronic paper, electronic display or other visible indicator.

The controller 130 controls delivery of an electric current from the power source 110 to the indicator 140. In some examples, the controller 130 provides at least one of constant and intermittent delivery of current from the power source 110 to the indicator 140. For example, the indicator sequence may include a series of blinking lights or an illumination for a specified time period.

In some implementations, the system 100 includes a processor 180. The storage device 170 may store one or more switch activation sequences. The processor 180 processes the sequence of activations of the activation switch 120 and determines if the sequence of activations matches one of the switch activation sequences stored in the storage device 170. Each switch activation may be time stamped. The processor 180 determines the sequence of the switch activations by comparing the time associated with each switch activation. The sequence stored in the storage device 170 may be faster or slower than the sequence of activation of the switch 120. In such cases, the processor 180 can identify the slower/faster activation pattern. For example, the pattern stored includes a sequence of first activation at t=0 seconds, second activation at t=1 seconds, third activation at t=3 seconds, fourth activation at t=5 seconds, and then the pattern repeats. The example describes a 1:2:2 pattern, where 1 is the difference between t=1 and t=2, 2 is the difference between t=3 and t=1, and the second 2 is the difference between t=5 and t=3. If the activation rate is as follows: first activation at t=0, second activation at t=2, third at t=6, and fourth at t=10 describing a sequence of activations having a pattern of 2:4:4 which describes a sequence two times as slow as the stored pattern.

In some examples, the indicator system 100 includes a sound sensor 190. The storage device 170 may store one or more rhythm pattern templates based on the sound sensed from the sound sensor 190. The processor 180 processes the sequence of activations of the activation switch 120 and compares it to the stored rhythm pattern templates. If the patterns are similar or match, a first indicator sequence is activated. If the patterns are not the same or similar, a second indicator sequence is activated.

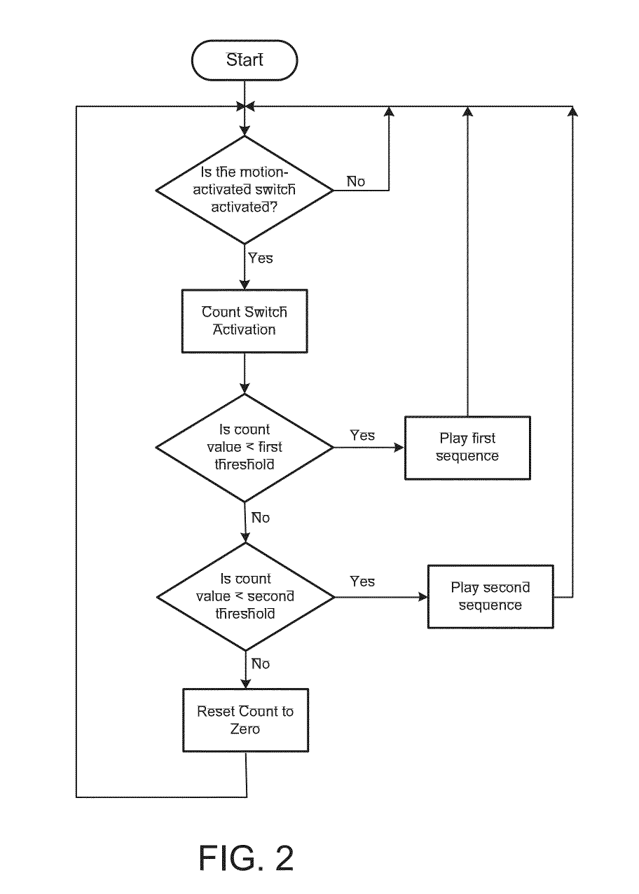

Referring to FIG. 2, in some implementations, the system 100 determines if the motion-activated switch 120 is activated. If the switch 120 is activated the counter 160 counts the switch activation (i.e., increments a count value 162). The controller 130 determines if the count value 162 of the counter 160 is greater than a first threshold value. The first threshold value can be any number (e.g., 1000, 2000, etc.). If the count value 162 is less than the first threshold value the controller 130 causes the indicator(s) 140 to play a first indicator sequence, and then the controller 130 determines if the switch 120 has been activated and repeats the process. If the count value 162 is not less than the first threshold value, i.e., the count value 162 is greater than or equal to the first threshold value, then the controller 130 determines if the count value 162 is less than a second threshold value. The second threshold value can be any number (e.g., 10, 20, 30, etc.). If the count value 162 is greater than or equal to the first threshold value and the count value 162 is less than the second threshold value, the controller 130 causes the indicator(s) 140 to play a second indicator sequence, and then determines if the switch 120 has been activated and repeats the process. If the count value 162 is greater than or equal to the first threshold value, but the count value 162 is not less than the second threshold value, then the counter 160 resets the count value 162 to zero. The system 100 repeats the process and the controller 130 checks if the switch 120 is activated, if so, the counter 160 counts the number 162 of activations until the conditions are met to run the first or second indicator sequence.

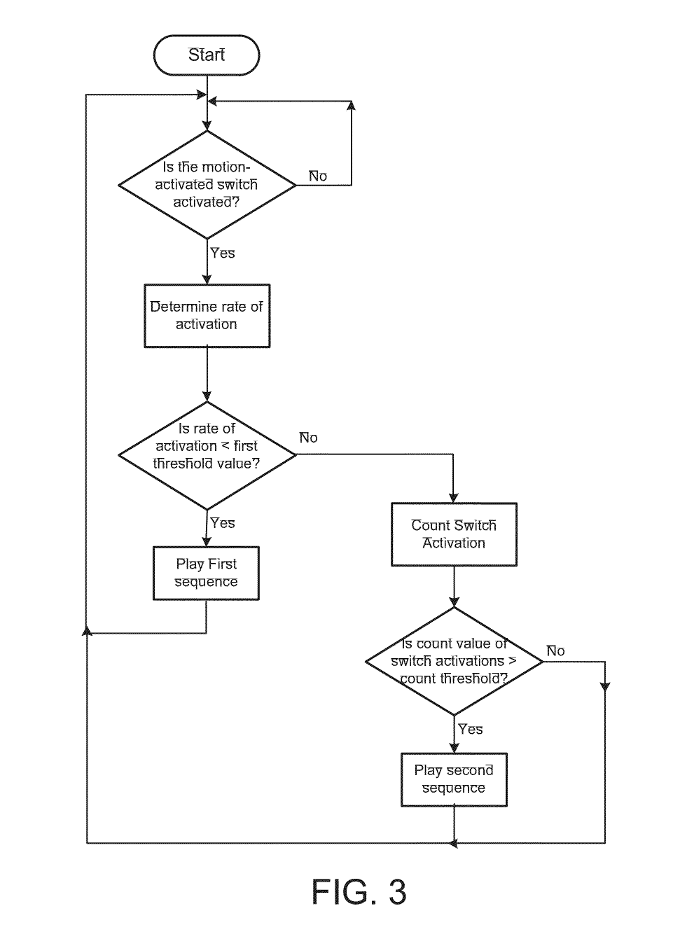

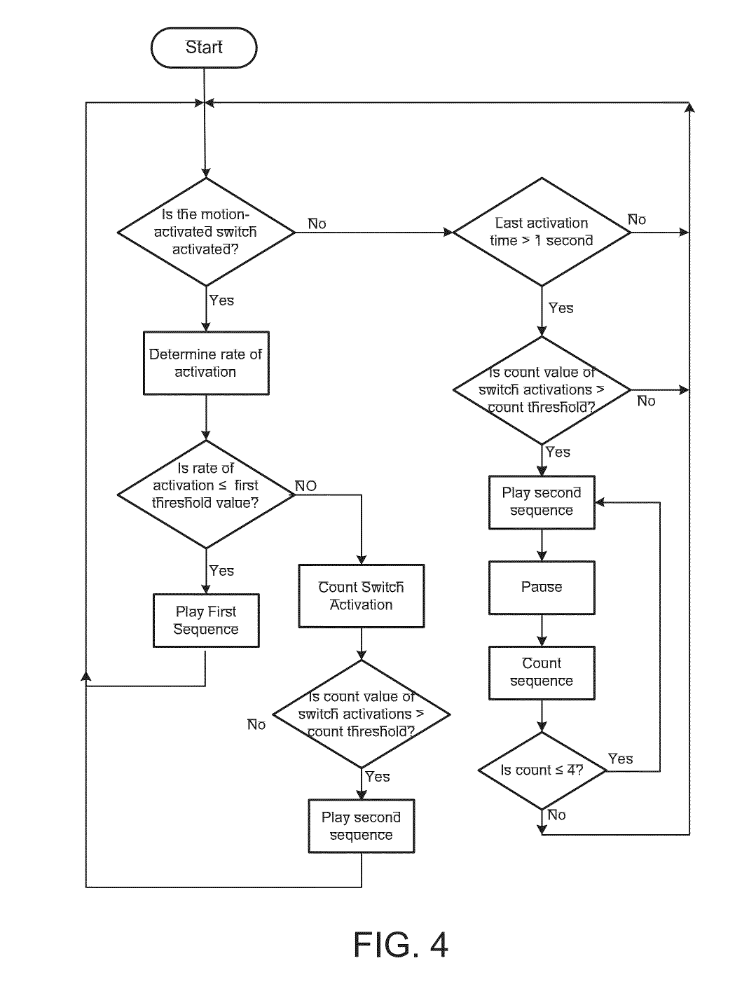

Referring to FIGS. 3 and 4, in some implementations, the system 100 determines if the motion-activated switch 120 is activated. If the switch 120 is activated, the rate determiner 166 determines the rate 164 of activation of the switch 120. The controller 130 then determines if the rate 164 of activation is less than a first threshold rate. If the rate 164 is not less than (i.e., greater than or equal to) the first threshold rate, the controller 130 causes the indicator(s) 140 to play a second indicator sequence. If the rate 164 is less than a first threshold rate, the counter 160 counts the switch activation (i.e., increments the count value 162). Next, the controller 130 determines if the count value 162 is greater than a first threshold count; if not, the controller 130 activates the indicator 140 according to the first indicator sequence. But if the count value 162 is greater than the threshold count, the controller 130 activates the indicator(s) 140 according to the second indicator sequence. In some examples, as shown in FIG. 4, when the count 162 of the total number of activations at a rate 164 greater than the first threshold rate and greater than the threshold count, and the switch 120 has not been activated for at least one second, then the controller 130 activates the indicator(s) 140 according to the second indicator sequence, pause for a short time (e.g., 0.5 seconds), and then repeat the sequence for a specified number of time (e.g., 4 times). Each time the controller 130 executes one of the indicator sequences, the controller 130 may decrement the counter 160.

In some examples, if an indicator sequence is activated (e.g., in execution) and the switch 120 detects motion, the controller 130 ignores the switch activation until the indicator sequence is complete. Therefore, during illumination of the indicator(s) 140, if the switch 120 detects a motion, the activation of the indicator 140 according to that indicator sequence is uninterrupted. The counter 160 may count the number of switch activations during one of the indicator sequences, and when that indicator sequence is complete, the controller 130 may activate the indicator 140 according to that same indicator sequence a number of times equal to the times that were counted.

In some implementations, when switch activation rate 164 is less than the threshold rate, the controller 130 decrements the switch count 162 for each activation of the motion-activated switch 120. When the switch activation rate 164 is less than the threshold rate and the switch count 162 is less than the threshold count, the controller 130 may activate the indicator 140 according to the first indicator sequence. Moreover, wherein when the switch activation rate 164 drops to zero within a threshold period of time (e.g., 1-5 seconds), and the switch count 162 is greater than the threshold count, the controller 130 may activate the indicator 140 according to the second indicator sequence a number of times (e.g., 1-10 times).

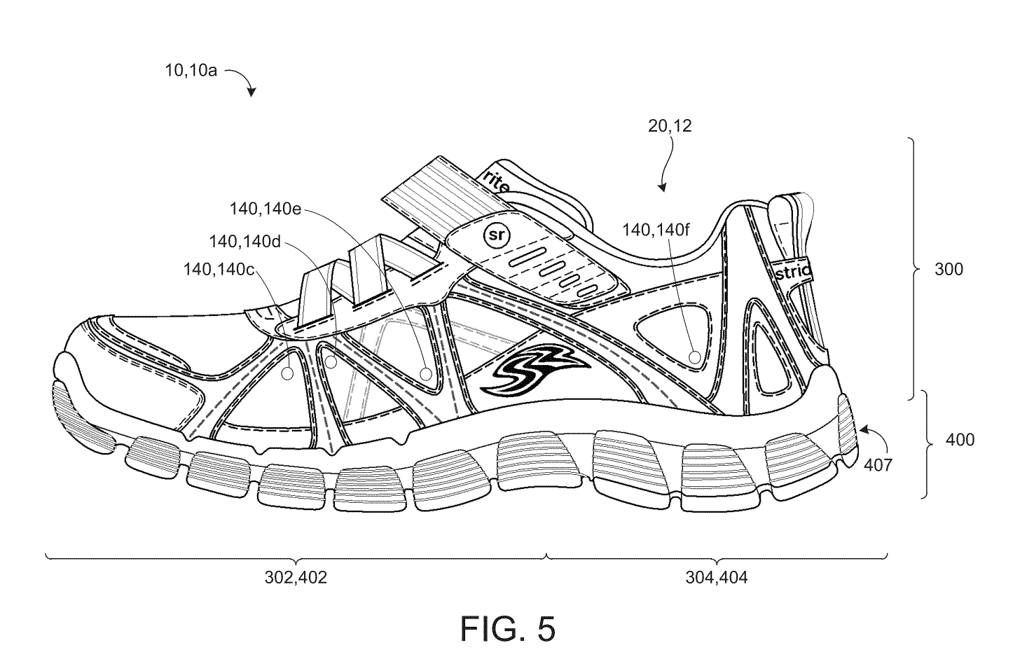

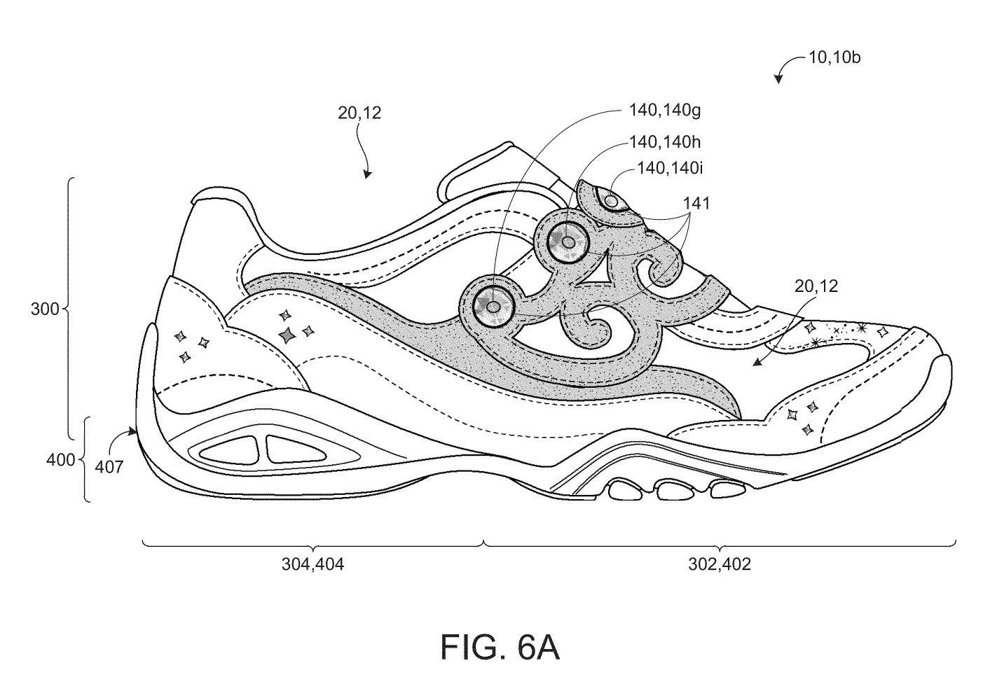

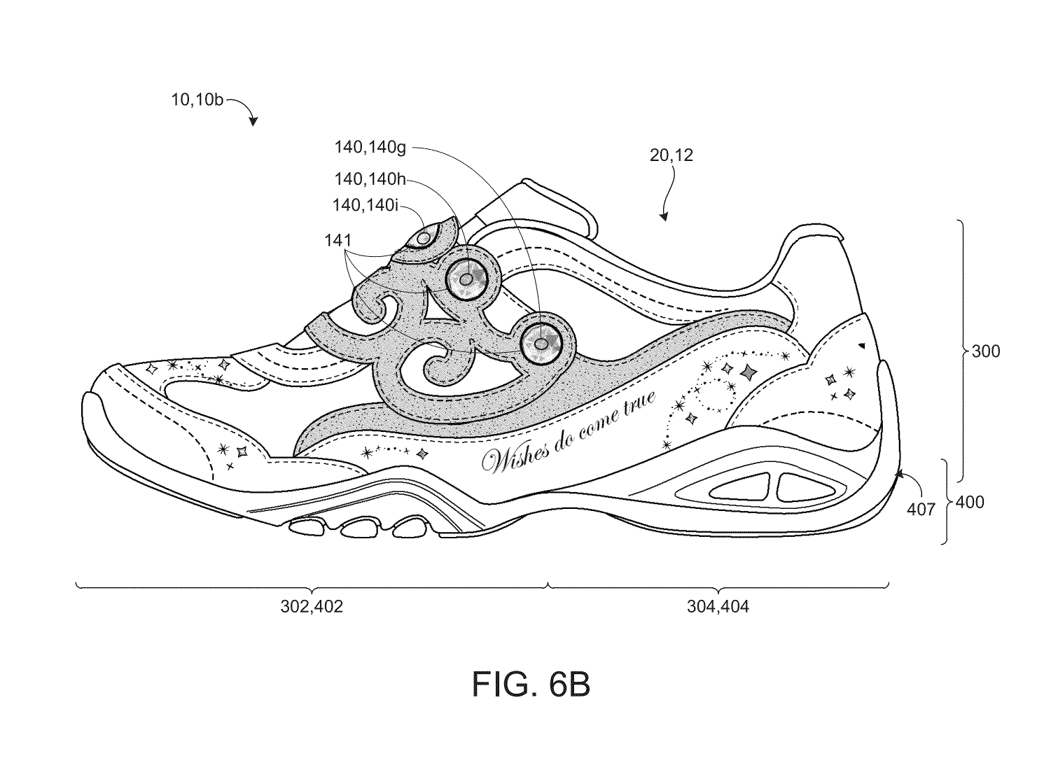

Referring to FIGS. 5, 6A, and 6B, in some implementations, the indicator system 100 is incorporated in an article of footwear. The article of footwear 10 includes an upper assembly 300 attached to a sole assembly 400 (e.g., by stitching and/or an adhesive). Together, the upper assembly 300 and the sole assembly 400 define a foot void 20 configured to securely and comfortably hold a human foot. The upper assembly 300 defines a foot opening 12 for receiving a human foot into the foot void 20. The upper assembly 300 and the sole assembly 400 each have a corresponding forefoot portion 302, 402 and a corresponding heel portion 304, 404. The forefoot portions 302, 402 may be generally associated with the metatarsals, phalanges, and interconnecting joints thereof of a received foot. The heel portions 304, 404 may be generally associated with the heel of the received foot, including the calcaneus bone. The forefoot portions 302, 402 and heel portions 304, 404 are only intended for purposes of description and do not demarcate precise regions of the footwear article 10. Although the examples shown illustrate a running shoe, the footwear article 10 may be configured as other types of footwear, including, but not limited to shoes, boots, sandals, flip-flops, clogs, etc. In some examples, the sole assembly includes an aperture (not shown) to fit the system housing 150. The indicator system 100 can be positioned in the heel 407 of the footwear 10, or any other location on the upper 300. The indicator 140 may be disposed on the upper assembly 300, the sole assembly 400, or both. As shown in FIGS. 6A and 6B, the indicators 140 are light emitters covered by transparent stones 141 of different shapes. The stones 141 may be of different size, shape, and/or color. When the light emitter 140 emits light, the stones 141 reflect the light making the light appear brighter and colorful. Other configurations or placements of the indicator(s) 140 may be used.

Referring back to FIG. 4 and FIGS. 5-6B, in some implementations, if a shoe wearer taps his/her foot once, then taps again two seconds later, then stops moving. The controller 130 may activate the indicator(s) 140 according to the first indicator sequence after the first tap and then after two seconds the controller 130 may activate the indicator(s) 140 according to the first sequence again. In some examples, considering the first threshold value to equal a value less than 3 seconds (e.g., 0.7 seconds), if the wearer taps his/her foot thirty times in fifteen seconds and then keeps tapping at a rate of one tap each half a second, the controller 130 may activate the indicator(s) 140 according to the second sequence after each tap. In another example, if the wearer taps his/her foot twenty five times in ten seconds, then stops moving, the controller 130 may activate the indicators 140 according to the second indicator sequence five times while the wearer is not moving. Each time the controller 130 executes one of the indicator sequences, the controller 130 may decrement the counter 160.

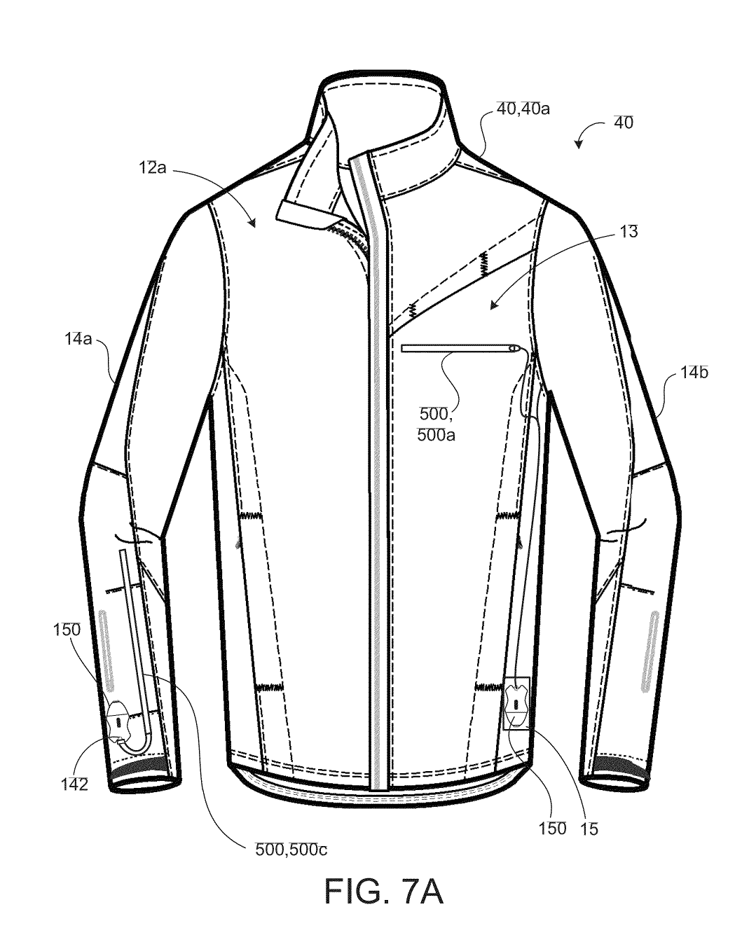

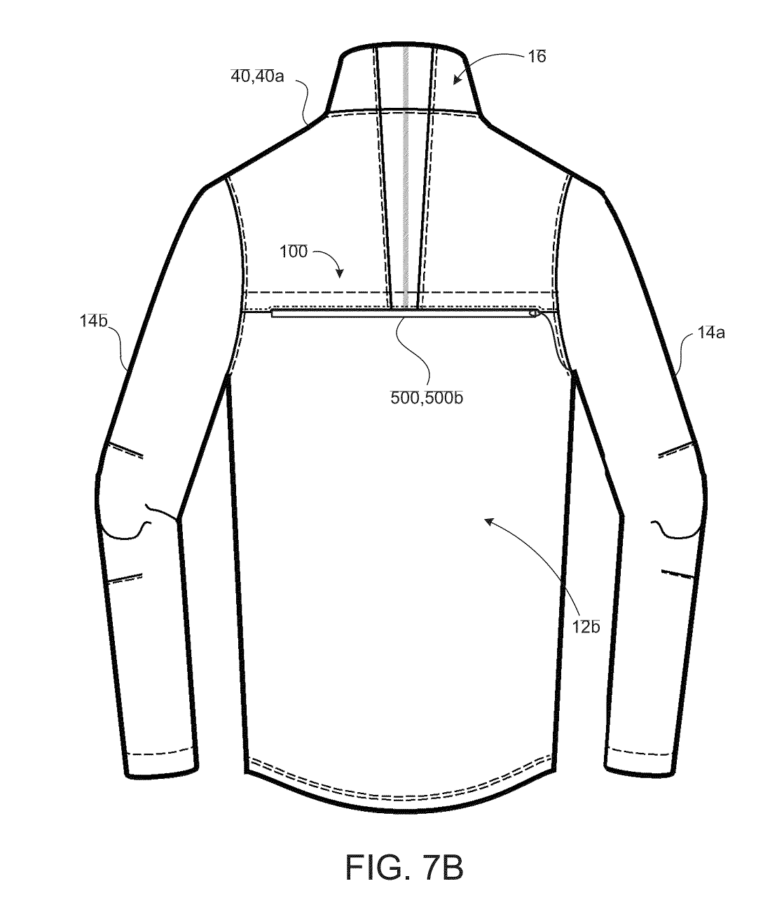

Referring to FIG. 7, in some implementations, the indicator system 100 is incorporated in an article of clothing 40 (e.g., shirt, jacket, shoe, hat, etc.), and includes at least one illuminable piping 500 disposed on the article of clothing 10 and the indicator 140 is arranged to emit light into the illuminable piping 500. The illuminable piping 500 may be fiber optic piping (e.g., extruded Polyurethane (PU) tubing), electroluminescent piping, an assembly of lights (e.g., light emitting diodes), or other lighting device. The illuminable piping 500 can be arranged in any manner on the article of clothing 40. For example, to provide visibility of a person at night, the indicator system 100 may include illuminable piping 500 disposed across a front surface 12a and/or rear surface 12b of the article of clothing 40 (e.g., a jacket 10a). The indicator system 100 includes a first illuminable piping 500a disposed substantially horizontally across a chest area 13 of the article of clothing 40. In FIG. 7B, the indicator system 100 includes a second illuminable piping 500b disposed substantially horizontally across the rear surface 12b of the article of clothing 40. Although the second illuminable piping 500b is shown disposed substantially horizontally, it may be disposed in any other orientation as well (e.g., vertically, diagonally, arcuately, etc.).

Other exemplary placements include, but are not limited to, along a top, bottom, front, rear, and/or side surfaces of the article of clothing 10. For example, on a jacket 10a, the illuminable piping 500, 500c can be arranged to run along right and/or left sleeves 14a, 14b of the jacket 10a and/or around a collar portion 16 of the jacket 40a. Other placements and arrangements are possible as well, for example, circular, arcuate, and polygonal arrangements.

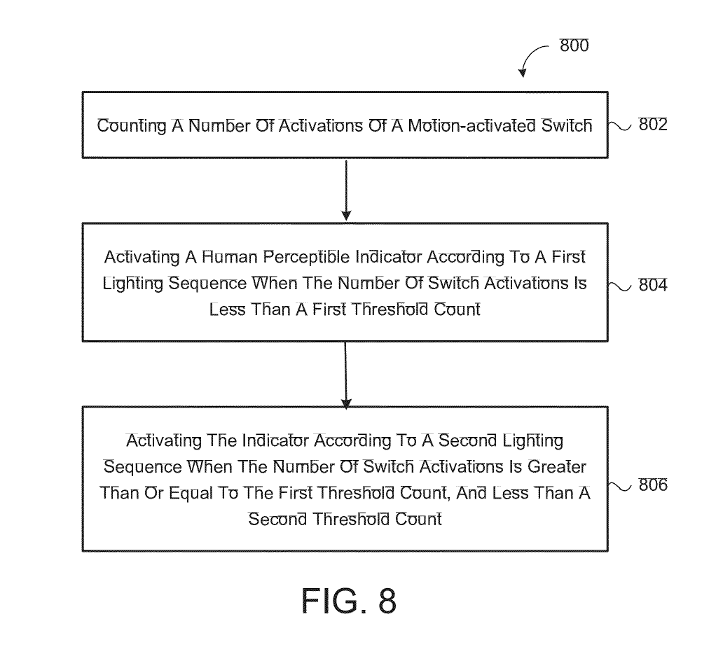

FIG. 8 provides an exemplary arrangement 800 of operations for a method of activating a human perceptible indicator 140. The method includes counting 802 a number of activations of a motion-activated switch 120. The method also includes activating 804, 806 the indicator 140 according to a first indicator sequence or a second indicator sequence, each of which may be stored non-transitory memory 170 of a controller 130. The first indicator sequence occurs when the number of switch activations is less than a first threshold count, and the second indicator sequence occurs when the number of switch activations is greater than or equal to the first threshold count, and less than a second threshold count. In examples, where the indicator 140 is a light emitter (e.g., light emitting diode (LED)), the method also includes causing 804, 806 illumination of the light emitter 140 according to a first indicator sequence or a second indicator sequence.

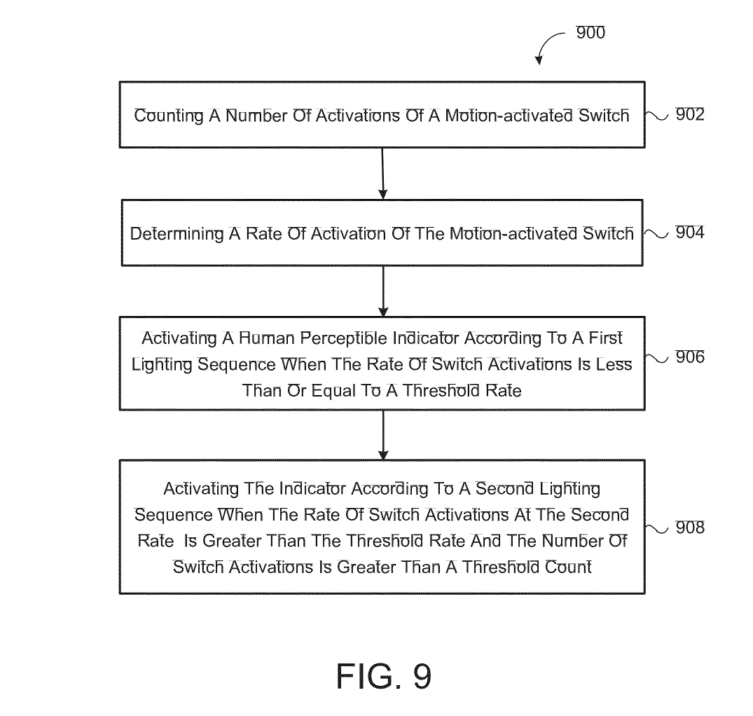

FIG. 9 provides another exemplary arrangement 900 of operations for a method of activating a human perceptible indicator 140. The method includes counting 902 a number of activations of a motion-activated switch 120 and determining 904 a rate 164 of activation of the motion-activated switch 120. The method also includes activating 906 the indicator 140 according to a first indicator sequence when the rate 164 of switch activations is less than or equal to a threshold rate. The method may also include activating 908 the indicator 140 according to a second indicator sequence when the rate 164 of switch activations is greater than the threshold rate and the number of switch activations at the second rate is greater than a threshold count. In some examples, the method further includes activating the indicator 140 (e.g., causing illumination of the light emitter 140) according to the second indicator sequence when the number of switch activations is greater than the threshold count at the second threshold rate and the switch 120 is not activated for at least a first time. The method 1000 may also include ceasing activating of the indicator 140 for a second time and then activating of the indicator 140 according to one of the indicator sequences. In some examples, the method includes resetting the count of switch activations to zero when the number of switch activations is equal to a second threshold count.

In some examples, the method includes delivering at least one of a constant or intermittent current to the indicator 140 (e.g., light emitter). For example, the indicator sequence may include a series of blinking lights or an illumination for a specified time. Additionally or alternatively, during an indicator sequence, if the switch 120 is activated that indicator sequence is uninterrupted. In some examples, the method further includes counting the number of switch activations during one of the indicator sequences, and illuminating at least one of the indicator sequences a number of times equal to the number of switch activations. Therefore, if the switch 120 is activated five times during an indicator sequence, the controller 130 causes the light emitter 140 to illuminate five times based on one of the indicator sequences.

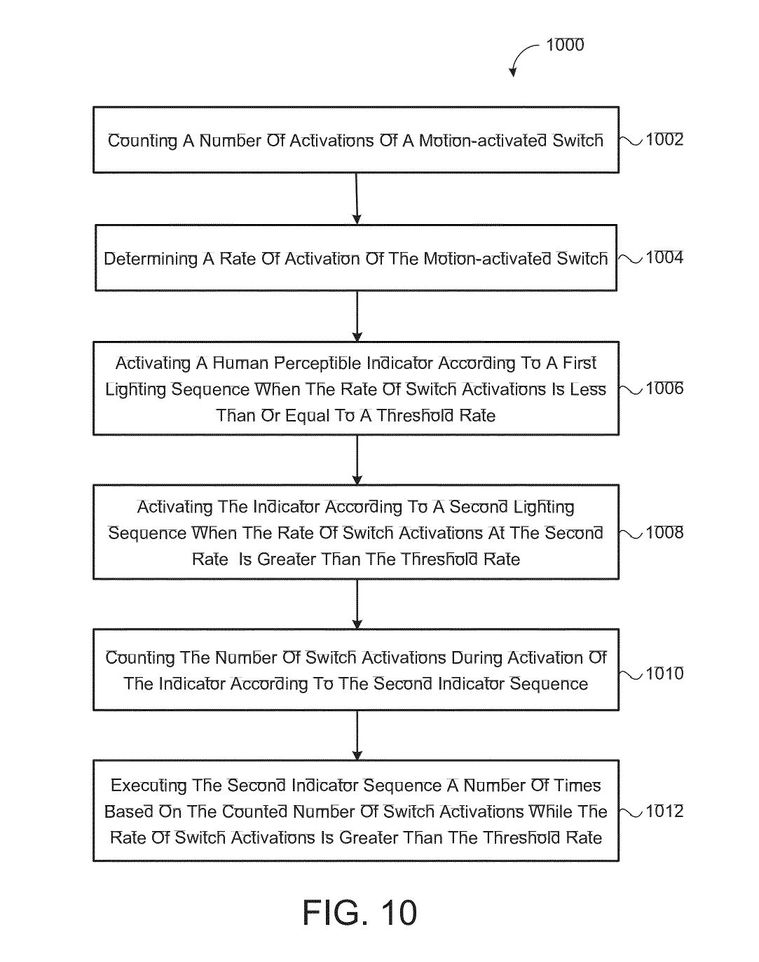

FIG. 10 provides another exemplary arrangement 1000 of operations for a method of activating a human perceptible indicator 140. The method includes counting 1002 a number of activations of a motion-activated switch 120, determining 1004 a rate 164 of activation of the motion-activated switch 120, and activating 1006 the indicator 140 according to a first indicator sequence when the rate 164 of switch activations is less than or equal to a threshold rate, and activating 1008 the indicator 140 according to a second indicator sequence when the rate 164 of switch activations is greater than the threshold rate. The method also includes counting 1010 the number 162 of switch activations during activation of the indicator 140 according to the second indicator sequence and executing 1012 the second indicator sequence a number of times based on the counted number of switch activations while the rate 164 of switch activations is greater than the threshold rate.

During activation of the indicator 140 according to the one of the indicator sequences, if the motion-activated switch 120 is activated, the activation of the indicator 140 according to that indicator sequence may be uninterrupted. The method may include decrementing the switch count 162 each time an indicator sequence is executed.

As is illustrated by the preceding examples, the indicator system may include different types of sensors, such as a motion-activated switch and a sound sensor, and the controller may use the sensors to control the output of the indicator. Although the preceding examples include motion-activated switches and sound sensors, the system may, generally speaking, include essentially any sensor (or combination of sensors) that might be useful in controlling indicator output. While this may include the motion-activated switch and/or the sound sensor previously described, it may additionally or alternatively include other types of sensors capable of providing readings indicative of essentially any physical property or other phenomenon internal or external to the article into which the indicator system is integrated. With regard to internal sensors, the indicator system may include sensors that provide, for example, readings of physical properties or other phenomena within the article, including without limitation sensors configured to provide readings of acceleration, force, humidity, position, orientation or temperature of the article. With regard to external sensors, the indicator may include, for example, photosensors/photodetectors or other light sensors (light or other electromagnetic energy of essentially any wavelength, including without limitation visible light and infrared light), accelerometers, magnetometer or other magnetic field sensors, electric field sensors, gravimeters or other gravitational field sensors, temperature sensors, particulate sensors, altimeters, humidity sensors, barometric pressure sensors, position sensors, inclinometers/clinometers, gyroscopes or angular rate sensors. As a further example, the sensor may be a communications antenna and it may be coupled with a controller capable of reading communications received by the antenna. For example, in one embodiment, the sensor may be an antenna that permits a controller to determine the presence and/or strength of a WiFi signal or other wireless communication network.

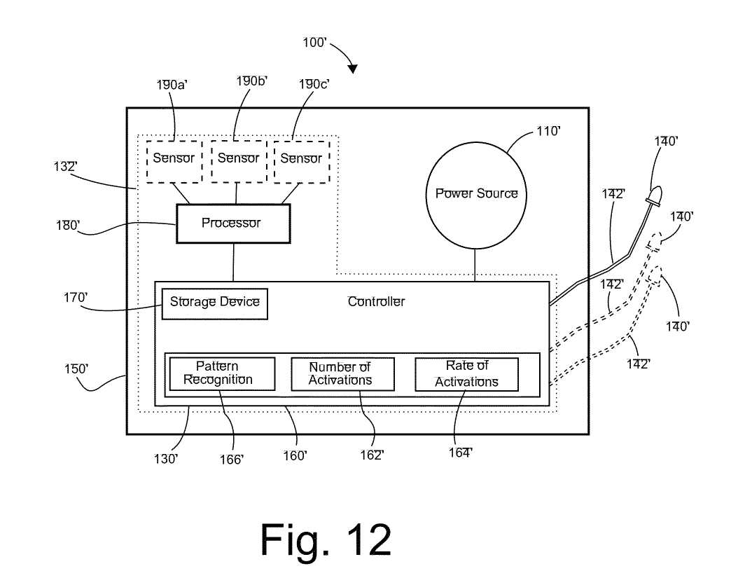

FIG. 12 is a schematic representation on one implementation of an indicator system 100′ configured to include a plurality of sensors 190a′, 190b′ and 190c′. Although FIG. 12 shows up to three sensors, the number of sensors may vary from application to application, as desired. The sensors may include a motion-activated switch, a sound sensor and/or any other type of sensor discussed above. In this exemplary embodiment, the controller 130′ includes pattern recognition logic 166′ that allows the controller 130′ to recognize patterns in sensor input (as described in more detail below). It may also include a counter 160′ with the ability to count the number of activations 162′ and/or the rate of activations 164′.

The sensors may be located in any appropriate location in or on the article. For example, in the context of footwear, one or more sensors may be incorporated into the upper and/or into the sole. With regard to the upper, one or more sensors may be disposed on, in or between layers forming the upper. In one implementation, a sensor may be sandwiched between a liner and another layer of the upper. In another implementation, a sensor may be disposed within the tongue. With regard to the sole, the sensor may be located on, in or between sole layers. In one implementation, a sensor may be disposed in a void in a midsole layer. In another implementation, a sensor may be embedded into the surface of sole layer where the sensor element is exposed to the exterior of the shoe. Among other things, the size, shape and other characteristics of the sensor, as well as the desire for comfort and aesthetic in the article may be taken into consideration when determining disposition of the sensor.

In use, these various sensors may allow the controller to control the indicator based on essentially any sensible physical property or other phenomenon (or combination of properties and phenomena) occurring internal or external to the article. For example, in use, the controller may determine the indicator sequence, indicator magnitude (e.g. volume for a sound indicator, vibration intensity or frequency if a haptic indicator and brightness or color if a light emitting indicator) or some other characteristic of the indicator output based on the output of the sensor(s). The controller may be configured to control indicator output based on one or more characteristics of the sensor readings, such as the value of the readings, a count of the number of readings, the rate at which readings occur or by a pattern that may be recognized in the readings over time. In one embodiment, the system may store threshold data relating to sensor readings or characteristics of the sensor readings, and the controller may be configured to provide different indicator outputs based on a comparison of the actual sensor readings with the stored threshold data. For example, the controller may vary the indicator output if the value of the sensed reading passes a threshold value. As another example, the controller may vary the indicator output if the number of sensor readings or the rate of sensor readings exceeds a threshold number or threshold rate. As yet another example, the controller may vary the indicator output if the sensor readings match or are sufficiently close to a threshold pattern. The controller may be configured to use essentially any pattern recognition algorithm, such as the pattern recognition algorithm discussed above in connection with the activation sequences of the motion-activated switch. With pattern recognition, an indicator system with a sound sensor may be able to change indicator output based on changes in the bass beat in music, changes in the decibels and/or changes in sound frequency. With a light sensor, the indicator system may adjust indicator output based on sensed color sequences or changes in sensed brightness. These are merely examples and it should be appreciated that the controller may be configured to allow it to recognize and respond to essentially any pattern that might be present in any sensor readings over time.

In one implementation that includes a sound sensor, the controller may control the indictor output based on music or other sound sensed by the sound sensor. For example, the controller may cause a light emitter to blink with a bass beat, become brighter or dimmer with changes in volume or frequency or otherwise vary in concert with the music or other sounds sensed by the sound sensor. This embodiment may be implemented generally in accordance with the indicator systems shown in FIGS. 1A and 1B, except that the motion-activated switch and related components may be eliminated, if desired. In one embodiment, the indicator system may be incorporated into a pair of shoes and it may generally include a separate controller, sound sensor and indicator incorporated into each shoe. Each controller may be configured to control the indicator output of that shoe to match readings provided to the controller by the corresponding sound sensor. For example, the indicator may be an LED that, as noted above, is illuminated to match the bass beat in the music or that is made dimmer and brighter in concert with music. As yet another example, the indicator may be a plurality of different color LEDs and the plurality of LEDs may be illuminated alone or in different combinations to produce colors that change with music or other sensed sounds.

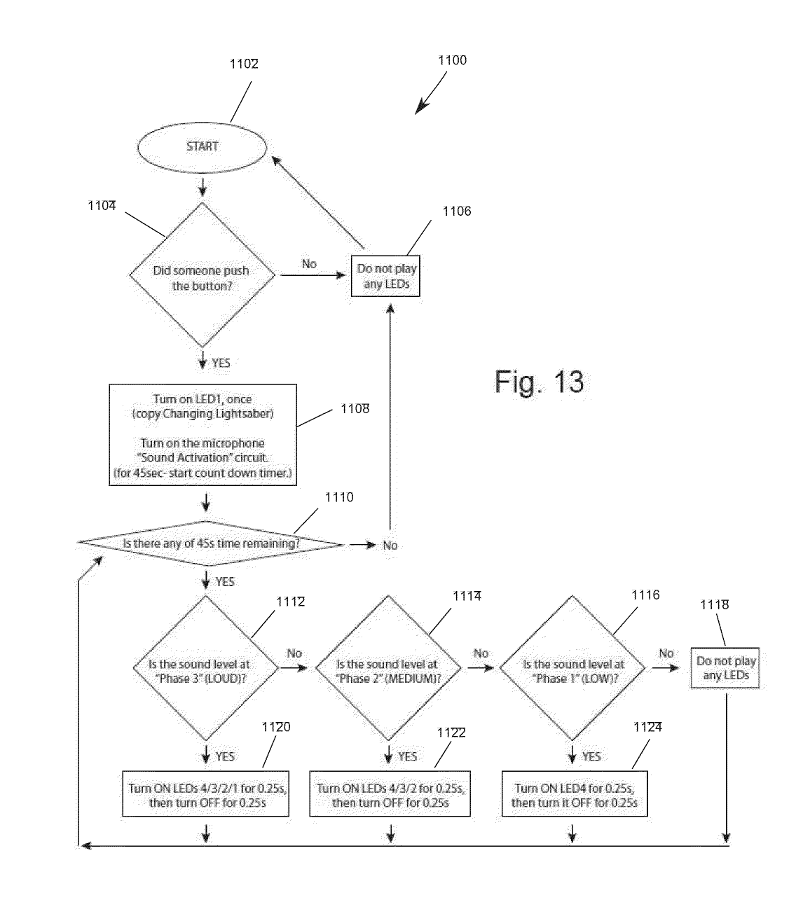

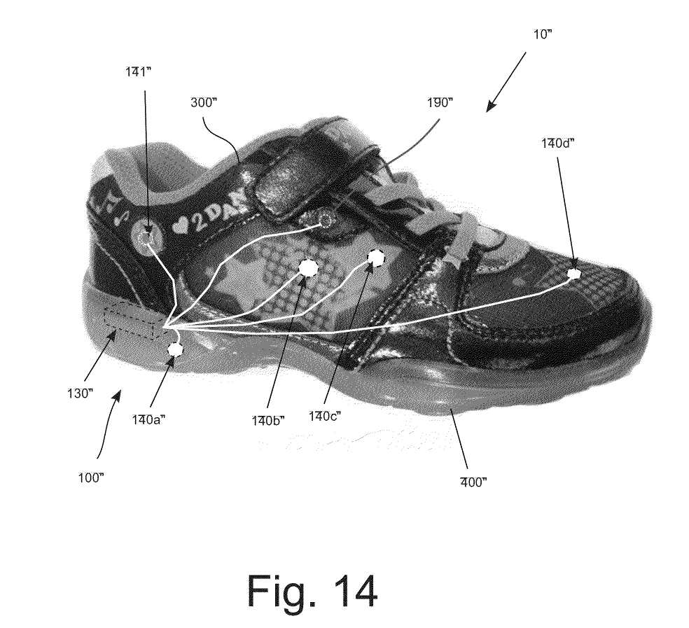

In one implementation that includes a sound sensor, the indicator system may be incorporated into a pair of shoes that includes a plurality of light emitters that are illuminated based on the output of a sound sensor (See FIGS. 13 and 14). The sound sensor may be essentially any component capable of providing analog or digital signals representative of sound in the environment. For example, the sound sensor may be a microphone that produces an analog output representative of the sound. The analog output may be converted to digital signals and analyzed by the controller. The analog to digital conversion may be carried out by the controller or by a separate analog to digital converter disposed between the sound sensor and the controller. As another example, the sound sensor may be capable of producing a digital output representative of the sound in the environment, such as a digital microphone. In this example, the digital output may be supplied to the controller for analysis. In the embodiment of FIG. 14, the shoe 10″ includes an indicator system 100″ generally including a controller 130″, a plurality of light emitters 140a-d″, an enable switch 141″ and a sound sensor 190″. In this embodiment, the light emitters 140a-d″ may be controlled by the controller 130″ as a function of essentially any characteristic of sound that can be directly or indirectly determined from the output of the sound sensor 190″. For example, the controller 130″ may drive the light emitters 140a-d″ as a function of the volume of the sound (e.g. decibel level) and/or the frequency content (e.g. magnitude of the bass, midrange and/or treble content of the sensed sound). In the embodiment of FIGS. 13 and 14, the light emitters 140a-d″ are controlled as a function of the volume or loudness of the sound.

More specifically, in this embodiment, the controller 130″ is configured to illuminate a different number of light emitters 140a-d″ depending on the volume of the sound sensed by the sound sensor 190″. In this embodiment, the number of light emitters 140a-d″ illuminated will increase with the volume of the sound sensed by the sound sensor (as will be described in more detail below). As noted above, the system 100″ includes an enable switch 141″ for enabling the system 100″ for a period of time. The use of an enable switch may provide various benefits, such as limiting battery consumption and to preventing flashing when not desired. In the embodiment of FIGS. 13 and 14, the indicator system 100″ includes a user-operated enable switch 141″ that activates the system for 45 seconds or until the enable switch 141″ is pressed a second time, whichever occurs first. Although the indicator system 100″ is active for 45 seconds in this embodiment, the activation time may vary from application to application. As an alternative (or in addition) to a predetermined activation time, the system may remain active until an event has occurred. For example, the system may remain active until the sound sensor fails to sense sound above a threshold volume for a sufficient period of time or remain active until the enable switch 141″ is actuated a second time.

The way in which the light emitters 140a-d″ are illuminated may vary from application to application. In the embodiment of FIG. 13, the controller 130″ may be configured to blink a different number of lights depending on the volume of the sound. In this embodiment, the number of light emitters that are blinked by the controller may increase with the volume of the sound. Each blink may be implemented by turning a light emitter on for a period of time and then turning that light emitter off for a period of time. The length of the “on” and “off” periods may vary from application to application. The light emitters 140a-d″ may be blinked one or more times, as desired. As an alternative to blinking the light emitters, the controller 130″ may implement other illumination methods. For example, instead of blinking the light emitters, the controller 130″ may turn on the number of light emitters that correspond with the volume of the sound for as long as the system is active. With this approach, there may be no “off” period implemented by the controller 130″. Instead, while the system is active, the controller 130″ may periodically and repeatedly determine the volume of the sensed sound and turn on the number of light emitters that correspond with the determined volume.

Referring now to FIG. 14, the light emitters may be LEDs that are embedded in the shoe 10, such as LED 140a″ embedded in a sole assembly 400″ and LEDs 140b-d″ embedded at different locations in the upper assembly 300″. LED 140a″ may be disposed in a void (not shown) defined in a translucent outsole, midsole or other sole component. LEDs 140b-d″ may be positioned and secured in place between different layers of the upper assembly 300″. The outer layer of the upper assembly 300″ may be manufactured from a material selected to allow the LEDs to be readily visible from the exterior of the shoe. If desired, the light emitters 140a-d″ may vary in color. For example, in the illustrated embodiment, the light emitter 140a″ is a blue LED, light emitter 140b″ is a green LED, light emitter 140c″ is a red LED and light emitter 140d″ is a green LED. This color arrangement is merely exemplary and may vary from application to application. The number and position of LEDs may vary from application to application as desired. The enable switch 141″ may be a push button switch disposed in the upper assembly 300″ where it is easily accessible to the user. Other types of switches may be used and the switch 141″ may be located in other positions on the shoe 10″. The enable switch 141″ may be covered by a durable material, such as plastic or rubber. The sound sensor 190″ may be a microphone disposed in the outer side of the upper assembly 300″. The microphone 190″ may be covered by a fabric or other material selected to allow sound to readily pass from the environment to the microphone 190″. The type and position of the microphone 190″ may vary from application to application as desired. The controller 130″ may be positioned in a void (not shown) in the sole assembly 400″, and may be operatively joined to the enable switch 141″, light emitters 140a-d″ and sound sensor 190″ by appropriate electrical leads. The electrical leads may be sandwiched between layers of the upper assembly 300″.

One method of operation of the indicator system of FIG. 14 is described with reference to the flow chart 1100 of FIG. 13. In this implementation, the indicator system 100″ remains idle 1102, 1104 and 1106 until the enable switch 141″ is actuated. Upon activation, the controller 130″ turns on 1108 light emitter 140a″ as a feedback signal confirming activation of the system 100″, begins to monitor the output of the sound sensor 190″ and starts a 45 second count down timer. The feedback signal may vary from application, or be eliminated if undesired. As noted above, the length of the activation period, and consequently, the length of the timer may vary from application to application, as desired. The system may be configured to additionally or alternatively remain enabled until the occurrence of a disable event, such as a second operation of the enable switch or until the sound sensed by the sound sensor falls below a predetermined volume for a specified period of time. With this implementation, once enabled, the controller 130″ monitors the output of the sound sensor 190″ and activates the light emitters 140a-d″ based on the volume of the sound. More specifically, in this embodiment, the controller 130″ is programmed to evaluate the sound sensor 191″ output and recognize three different volume thresholds, namely LOW, MEDIUM and LOUD. The number of thresholds and the value of each different threshold may vary from application to application. When the controller 130″ determines that the decibel level of the output of the sound sensor 191″ is below the LOW threshold, the controller 130″ does not illuminate 1118 any of the light emitters 140a-d″. When the controller 130″ determines 1116 that the decibel level of the output of the sound sensor 191″ is above the LOW threshold and below the MEDIUM threshold, the controller 130″ illuminates 1124 LED 140a″ for 0.25 seconds and then turns it off for 0.25 seconds. When the controller 130″ determines 1114 that the decibel level of the output of the sound sensor 191″ is above the MEDIUM threshold and below the LOUD threshold, the controller 130″ illuminates 1122 LED 140a″, LED 140b″ and LED 140c″ for 0.25 seconds and then turns all three LEDs off for 0.25 seconds. When the controller 130″ determines that the decibel level of the output of the sound sensor 191″ is above the LOUD threshold, the controller 130″ illuminates 1120 LED 140a″, LED 140b″, LED 140c″ and LED 140d″ for 0.25 seconds and then turns all four LEDs off for 0.25 seconds. As can be seen, in this embodiment, the controller 130″ illuminates an increasing number of light emitters as the volume of sound increases. This lighting pattern is merely exemplary and the light emitters that are illuminated for different volume thresholds may vary from application to application. Further, the amount of time that the light emitters are illuminated and the amount of time they are kept off for each threshold may vary. As can be seen, the controller 130″ remains active in illuminating the light emitters in response to sound until the count down timer has expired 1110. Although not shown in FIG. 13, the controller 130″ may also be configured to deactivate the indicator system 100″ if the enable switch 141″ is actuated a second time before the count down timer has expired. When the count down timer has expired (or the enable switch is actuated a second time), control returns 1110 to the start block 1102 and the system remains inactive 1102, 1104, 1106 until the enable switch 141″ is pressed.

In another implementation, the indictor system may be incorporated into a pair of shoes and the sensor may be configured to adjust indictor output based at least in part on the relative motion and/or relative position of the two shoes. This may allow the system to provide relatively complex interaction with the wearer. In one implementation, the indicator system may be configured to teach a wearer dance steps or other foot movements by providing a “reward” when the wearer of the shoes moves the shoes appropriately. For example, in one embodiment, the right shoe may include a controller and a sound sensor configured to illuminates a blue LED in the right shoe when a certain musical note or sequence of notes is recognized by the controller and sound sensor. The left shoe may include a controller and a blue light sensor that is positioned so that it only senses the blue LED light emitted by the right shoe when it is in an appropriate position. When the controller and the blue light sensor in the left shoe sense the blue light at an appropriate time, the indicator in the left shoe may provide the “reward” by providing an output indicating that correct motion and/or position of the shoes has occurred. By stringing together a series of illuminations of the blue LED in the right shoe and recognition of the blue light in the left shoe, it is possible to provide indicator output that moves the wearer through a series of dance steps or foot movements. This sequencing and control may become more complicated in alternative embodiments by incorporating additional light emitters and additional light sensors into the shoes so that the shoes can recognize different relative positions between the shoes. For example, the shoes may include one light emitter and light sensor pair that align only when the shoes are roughly in line in a lateral direction and a second light emitter and light sensor pair that align only when the right shoe is positioned in front of the left shoe. This concept can be extended to additional emitter/sensor pairs to expand the ability of the indicator system to recognize additional relative positions. As another example, one shoe may include a single light emitter and the other shoe may include a plurality of separate light sensors that will alternatively sense the emitted light depending on the relative position of the two shoes. Again, additional light emitters and sensors may be added to provide expanded capabilities. If desired, the indicator system and associated control algorithms may also include motion sensing to add an additional level of feedback and control. For example, each shoe may include a motion sensor and the movement of the shoes may be taken into account when determining whether the wearer has followed the correct dance steps or foot movements. In one embodiment expanding on the prior example, the controller of the right shoe may only illuminate the blue LED if the right shoe has undergone the appropriate motion when a certain note or sequence of notes has occurred. Similarly, the indicator output may only change to the “reward” sequence when the left shoe has sensed the blue light and undergone an appropriate motion. In this example, the motion sensor may be a simple motion-activated switch that recognizes motion, but not the direction of motion. In another example, the shoes may incorporate a more complicated motion sensor (or combination of motion sensors) that can sense motion and recognize the direction in which the motion occurred. For example, in these embodiments, the indicator system may include the alternative spring switch discussed above. As another example, the indicator system may include a plurality of single direction motion sensors (e.g. reed switch) arranged at different orientations so that different motion sensors are activated depending on the direction of the motion. In use, this may allow the system to recognize and differentiate between up/down and left/right movement of a shoe,

In some applications, it may be desirable to allow the indicator system to operate in alternative modes of operation. This may be particularly useful when the indicator system is capable of operating in one mode of operation that consumes limited power and a second mode of operation of that consumes significantly more power. By limiting the amount of time the indicator system operates in the second mode, the amount of power consumed by the system can be reduced. This may reduce the need to replace batteries or to charge an internal electrical energy storage device (e.g. a rechargeable battery or a super capacitor). For example, a mode of operation in which the light emitters vary in response to music can consume a significant amount of power, whereas a mode of operation in which the light emitters are triggered by repeated activation of a motion-activated switch is likely to consume significantly less power. To conserve power consumption, it may be desirable to for an indicator system that has a music-activated mode of operation to also have a motion-activated mode of operation. In fact, it may be desirable for the indicator system to enter into the lower-power mode of operation as a default or after a period of time in the higher-power mode of operation. In such embodiments, it may be desirable to provide a mechanism that allows a user to select the desired mode of operation. In one embodiment, the indicator system includes a simple mechanical switch that can be activated by the user. For example, the indicator system may include a toggle switch, a button switch or essentially any other type of switch that can be manually operated by a wearer. In another embodiment, the indicator system may be able to receive input through one or more the integrated sensors to trigger a change between modes of operation. In embodiments with a motion sensor, the controller may monitor the motion sensor activations to determine if a specific activation sequence occurs that constitutes an instruction to change modes of operation. For example, the controller may be programmed to recognize four quick activations as a signal to change modes of operations. The activation sequence required to change modes of operation may vary from application to application as desired. In one embodiment, the motion sensor may be a switch capable of differentiating between up/down (e.g. generally associated with heel strike) and left/right motion (generally associated with moving the shoes toward and away from each other). In this embodiment, the user may direct the controller to switch modes of operation by providing motion in the left/right direction rather than in the up/down direction. For example, in one implementation incorporated into a pair of shoes, there may be a separate controller in each shoe and each controller may be configured to switch between modes of operation when that controller determines that the user has clicked the heels of the shoes together a sufficient number of times. More specifically, the controller in each shoe may determine that a “change mode” action has occurred when a sequential number of activations in the left/right direction has occurred within a specified period of time (e.g. three heel clicks within two seconds). If the motion sensor is capable of differentiating between inward and outward motion, the controllers may be configured to switch modes of operation when inward and outward motion occurs in sequence a specific number of times (e.g. three consecutive sequences of inward and outward motion). A number of implementations have been described. Nevertheless, it will be understood that various modifications may be made without departing from the spirit and scope of the disclosure. Accordingly, other implementations are within the scope of the following claims.

What is claimed is:

1. An indicator system comprising:
a human perceptible indicator;
a motion-activated switch; and
a controller in electrical communication with the indicator and the motion-activated switch, the controller comprising:
non-transitory memory storing first and second indicator sequences; and
a counter counting a number of activations of the motion-activated switch;
wherein the controller activates the indicator according to:
the first indicator sequence when the number of switch activations is less than a first threshold count; and
the second indicator sequence when the number of switch activations is greater than or equal to the first threshold count and less than a second threshold count.

2. The system of claim 1, wherein during activation of the indicator according to the one of the indicator sequences, if the motion-activated switch is activated, the activation of the indicator according to that indicator sequence is uninterrupted.

3. The system of claim 2, wherein the counter counts the number of switch activations during activation of the indicator according to one of the indicator sequences, and the controller executes that indicator sequence a number of times based on the counted number of switch activations.

4. The system of claim 3, wherein the controller decrements the switch count each time an indicator sequence is executed.

5. The system of claim 1, wherein the counter resets to zero when the number of switch activations is equal to the second threshold count.

6. The system of claim 1, wherein the first indicator sequence is different than the second indicator sequence.

7. The system of claim 1, wherein the indicator comprises a light emitter.

8. The system of claim 7, wherein the light emitter comprises at least one light emitting diode.

9. The system of claim 8, wherein the light emitter comprises multiple differently colored light emitting diodes.

10. The system of claim 9, wherein the light emitter comprises a multi-color light emitting diode.

11. The system of claim 10, wherein the first indicator sequence includes a first color of the multi-color light emitting diode, and the second sequence includes a second color of the multi-color light emitting diode.

12. The system of claim 1, wherein the indicator is disposed remotely from the motion-activation switch.

13. The system of claim 1, further comprising a power source in electrical communication with at least one of the indicator, the motion-activated switch, or the controller.

14. The system of claim 12, wherein the power source provides a constant or intermittent delivery of current to the indicator.

15. The system of claim 12, wherein the controller activates the indicator by allowing the power source to power the indicator.

16. An indicator system comprising:
a human perceptible indicator;
a motion-activated switch; and
a controller in electrical communication with the indicator and the motion activated switch, the controller comprising:
non-transitory memory storing first and second indicator sequences; and
a counter counting a number of activations of the motion-activated switch and determining a rate of activations of the motion-activated switch;
wherein the controller activates the indicator according to:
the first indicator sequence when the rate of switch activations is less than or equal to a threshold rate; and
the second indicator sequence when the rate of switch activations is greater than the threshold rate and the number of switch activations at the second rate is greater than a threshold count.

17. The system of claim 16, wherein during activation of the indicator according to one of the indicator sequences, if the motion-activated switch is activated, the activation of the indicator according to that indicator sequence is uninterrupted.

18. The system of claim 17, wherein the counter counts the number of switch activations during activation of the indicator according to one of the indicator sequences, and the controller executes that indicator sequence a number of times based on the counted number of switch activations.

19. The system of claim 16, wherein the controller decrements the switch count each time an indicator sequence is executed.

20. The system of claim 16, wherein the counter resets to zero when the number of switch activations is equal to a second threshold count.

21. The system of claim 16, wherein the controller activates the indicator according to the second indicator sequence when the number of activations is greater than the threshold count at the second threshold rate and the motion-activated switch is unactivated for at least a first time period.

22. The system of claim 16, wherein the controller ceases activation of the indicator for a second time period, and then causes activation of the indicator according to one of the indicator sequences.

23. The system of claim 16, wherein when switch activation rate is less than the threshold rate, the controller decrements the switch count for each activation of the motion-activated switch.

24. The system of claim 16, wherein when switch activation rate is less than the threshold rate and the switch count is less than the threshold count, the controller activates the indicator according to the first indicator sequence.

25. The system of claim 16, wherein when the switch activation rate drops to zero within a threshold period of time, and the switch count is greater than the threshold count, the controller activates the indicator according to the second indicator sequence a number of times.

26. The system of claim 16, wherein the indicator comprises a light emitter.

27. The system of claim 26, wherein the light emitter comprises at least one light emitting diode.

28. The system of claim 26, wherein the light emitter comprises a multi-color light emitting diode.

29. The system of claim 28, wherein the first indicator sequence includes a first color of the multi-color light emitting diode, and the second sequence includes a second color of the multi-color light emitting diode.

30. The system of claim 16, wherein the first indicator sequence is different than the second indicator sequence.

31. The system of claim 16, wherein the light emitter is disposed remotely from the motion-activation switch.

32. The system of claim 16, further comprising a power source in electrical communication with at least one of the indicator, the motion-activated switch or the controller.

33. The system of claim 32, wherein the power source provides at least one of a constant or intermittent delivery of current to the indicator.

34. The system of claim 32, wherein the controller activates the indicator by allowing the power source to power the indicator.

35. An indicator system comprising:
a human perceptible indicator;
a motion-activated switch; and
a controller in electrical communication with the indicator and the motion activated switch, the controller comprising:
non-transitory memory storing first and second indicator sequences; and
a counter counting a number of activations of the motion-activated switch and determining a rate of activations of the motion-activated switch;
wherein the controller activates the indicator according to:
the first indicator sequence when the rate of switch activations is less than or equal to a threshold rate; and
the second indicator sequence when the rate of switch activations is greater than the threshold rate; and
wherein the counter counts the number of switch activations during activation of the indicator according to the second indicator sequence, and the controller executes the second indicator sequence a number of times based on the counted number of switch activations while the rate of switch activations is greater than the threshold rate.

36. The system of claim 35, wherein during activation of the indicator according to the one of the indicator sequences, if the motion-activated switch is activated, the activation of the indicator according to that indicator sequence is uninterrupted.

37. The system of claim 35, wherein the controller decrements the switch count each time an indicator sequence is executed.

38. The system of claim 35, wherein the indicator comprises a light emitter.

39. The system of claim 38, wherein the light emitter comprises at least one light emitting diode.

40. The system of claim 35, further comprising a power source in electrical communication with at least one of the indicator, the motion-activated switch or the controller.

41. A method of activating a human perceptible indicator, the method comprising:
counting a number of activations of a motion-activated switch; and
activating the indicator according to:
a first indicator sequence when the number of switch activations is less than a first threshold count; and
a second indicator sequence when the number of switch activations is greater than or equal to the first threshold count, and less than a second threshold count.

42. The method of claim 41, further comprising delivering at least one of a constant or intermittent current to the indicator.

43. The method of claim 41, wherein while activating the indicator according to one of the indicator sequences, if the motion-activated switch is activated, that indicator sequence is uninterrupted.

44. The method of claim 43, further comprising:
counting the number of switch activations during one of the indicator sequences;
and executing at least one of the indicator sequences a number of times based on the number of switch activations.

45. The method of claim 44, further comprising decrementing the switch count each time an indicator sequence is executed.

46. A method of activating a human perceptible indicator, the method comprising:
counting a number of activations of a motion-activated switch;
determining a rate of activation of the motion-activated switch; and
activating the indicator according to:
a first indicator sequence when the rate of switch activations is less than or equal to a threshold rate; and
a second indicator sequence when the rate of switch activations is greater than the threshold rate and the number of switch activations at the second rate is greater than a threshold count.

47. The method of claim 46, further comprising delivering at least one of a constant or intermittent current to the indicator.

48. The method of claim 46, wherein while executing one of the indicator sequences, if the motion-activated switch is activated, that indicator sequence is uninterrupted.

49. The method of claim 46, further including:
counting the number of switch activations during one of the indicator sequences; and
executing at least one of the indicator sequences a number of times based on the number of switch activations.

50. The method of claim 46, further comprising activating the indicator according to the second indicator sequence when the number of switch activations is greater than the threshold count at the second threshold rate and the motion-switch is not activated for at least a first time.

51. The method of claim 46, further comprising ceasing activation of the indicator for a second time and then activating the indicator according to one of the indicator sequences.

52. The method of claim 46, further comprising resetting the count of switch activations to zero when the number of switch activations is equal to a second threshold count.

53. A method of activating a human perceptible indicator, the method comprising:
counting a number of activations of a motion-activated switch;
determining a rate of activation of the motion-activated switch;
activating the indicator according to:
a first indicator sequence when the rate of switch activations is less than or equal to a threshold rate; and
a second indicator sequence when the rate of switch activations is greater than the threshold rate;
counting the number of switch activations during activation of the indicator according to the second indicator sequence; and
executing the second indicator sequence a number of times based on the counted number of switch activations while the rate of switch activations is greater than the threshold rate.

54. The method of claim 53, wherein during activation of the indicator according to the one of the indicator sequences, if the motion-activated switch is activated, the activation of the indicator according to that indicator sequence is uninterrupted.

55. The method of claim 53, further comprising decrementing the switch count each time an indicator sequence is executed.

56. An indicator system comprising:
an indicator configured to provide an output;
a sensor configured to provide sensor readings; and
a controller in electrical communication with the indicator and the sensor, the controller configured to control the indicator output as a function of the sensor .

57. The system of claim 56, wherein the sensor is at least one of a light sensor, an accelerometer, a magnetic field sensor, an electric field sensor, a gravitational field sensor, a temperature sensor, a particulate sensor, an altimeter, a humidity sensor, a barometric pressure sensor, a position sensor, an inclinometer, a gyroscope, an angular rate sensors or a communications antenna.

58. The system of claim 57, wherein the controller is configured to recognize an input pattern in the sensor readings, the controller configured to control the indicator output as a function of the pattern.

59. The system of claim 57, wherein the sensor is a sound sensor and the controller is configured to control the indicator output as a function of sensed sounds.

60. The system of claim 59, wherein the controller is configured to control the indicator output as a function of the sensor readings from a plurality of sensors.

61. The system of claim 56, wherein the indicator is a light emitter and the controller is configured to vary the indicator output of the light emitter as a function of the sensor readings.

62. The system of claim 56, wherein the indicator is a light emitter and the controller is configured to vary the on-off state of the light emitter as a function of the sensor readings.

63. The system of claim 56, wherein the indicator is a light emitter and the sensor is a sound sensor, said controller varying at least one of the brightness and on-off status of the light emitter as a function of the sensor readings obtained from the sound sensor.

64. The system of claim 56, wherein the indicator is a light emitter and the sensor is a sound sensor, said controller configured to recognize at least one of a bass beat, a decibel level and a frequency in the sensor readings received from the sound sensor, said controller varying at least one of the brightness and on-off status of the light emitter as a function of at least one of the bass beat, the decibel level and the frequency recognized in the sensor readings.

65. The system of claim 56, wherein the controller is configured to operate in two different modes of operation and is capable of being selectively switched between the modes of operation.

66. The system of claim 65, wherein the indicator system includes a sound sensor and a motion sensor, the controller configured to vary indicator output based on the sensor readings from the sound sensor in the first mode of operation, the controller configured to vary indicator output based on the sensor readings from the motion sensor in the second mode of operation.

67. The system of claim 66, wherein the controller is configured to switch between the first mode of operation and the second mode of operation when the controller recognizes a predetermined activation pattern in the sensor readings from the motion sensor.

68. A pair of shoes comprising:
a first indicator system in a first shoe, the first indicator system including a first sensor, a first indicator and a first controller for controlling an output of the first indicator;
a second indicator system in a second shoe, the second indicator system including a second sensor, a second indicator and a second controller, the second sensor configured to sense the output of the first indicator, the second controller configured to controller the output of the second indicator as a function of the readings from the second sensor.

69. The shoes of claim 68, wherein the first indicator is a light emitter and the second sensor is a light sensor configured to sense light emitted by the first indicator.

70. The shoes of claim 69, wherein the first indicator and the second sensor are arranged so that the light emitted by the first indicator is sensible by the second sensor only when the first shoe and the second shoe are in a predetermined relative position.

71. The shoes of claim 70, wherein the first indicator is disposed adjacent an inner surface of the first shoe and the second sensor is disposed adjacent an inner surface of the second shoe.

72. The shoes of claim 68, wherein the first controller and the second controller are configured to operate in two different modes of operation and are capable of being selectively switched between the modes of operation.

73. The shoes of claim 72, wherein at least one of the first shoe and the second shoe includes a motion senor providing sensor readings, at least one of the first controller and the second controller configured to switch between the first mode of operation and the second mode of operation upon recognition of a predetermined activation pattern in the sensor readings from the motion sensor.

74. An indicator system for an article of footwear comprising:
a sound sensor;
a plurality of light emitters;
a controller in electrical communication with the sound sensor and the plurality of light emitters, the controller having memory storing data representative of at least two different sound ranges, the controller configured to activate the light emitters differently based on a comparison of an output of the sound sensor with the sound ranges.

75. The indicator system of claim 75 wherein the data representative of the sound ranges includes sound volume thresholds.

76. The indicator system of claim 75 wherein the controller is configured to light a different number of the light emitters depending on a comparison of the output of the sound sensor with the sound volume thresholds.

76. The indicator system of claim 74 further including an enable switch operatively coupled to the controller, the controller configured to temporarily activate the indicator system upon actuation of the enable switch.

77. The indicator system of claim 74 further including an enable switch operatively coupled to the controller, the controller configured to activate the indicator system for a predetermined period of time upon actuation of the enable switch.

78. The indicator system of claim 74 wherein the controller stores at least three different sound ranges, the controller configured to activate no light emitter when the sensed sound is not within any of the sound ranges, to activate a first number of the light emitters when the sensed sound is within the first sound range, to activate a second number of the light emitters when the sensed sound is within the second sound range and to activate a third number of light emitters when the sensed sound is within the third sound range.

79. The indicator system of claim 75 wherein the controller stores at least three different sound volume thresholds, the controller configured to activate no light emitter when the volume of the sensed sound is below a first of the sound volume thresholds, to activate and then deactivate a first number of the light emitters when the volume of the sensed sound is above the first of the sound volume thresholds, to activate and then deactivate a second number of the light emitters when the volume of the sensed sound is above a second of the sound volume thresholds and to activate and then deactivate a third number of light emitters when the volume of the sensed sound is above a third of the sound volume thresholds.

80. The indicator system of claim 74 wherein the controller stores at least three different sound volume ranges, the controller configured to activate no light emitter when the sensed sound is not within any of the sound volume ranges, to activate a first number of the light emitters when the sensed sound is within the first sound volume range, to activate a second number of the light emitters when the sensed sound is within the second sound volume range and to activate a third number of light emitters when the sensed sound is within the third sound volume range.
